(19) United States
(12) Patent Application Publication
(10) Pub. No.: US 2015/0093933 A1
(43) Pub. Date: Apr. 2, 2015

(54) FIXING DEVICE FOR TWO CONNECTED CONNECTORS

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventors: AN-GANG LIANG, Shenzhen (CN); MING-YU LIU, Shenzhen (CN); HUNG-YI WU, New Taipei (TW)

(73) Assignees: HONG FU JIN PRECISION INDUSTRY (ShenZhen) CO. LTD., Shenzhen (CN); HON HAI PRECISION INDUSTRY CO., LTD., New Taipei (TW)

(21) Appl. No.: 14/056,973

(22) Filed: Oct. 18, 2013

(30) Foreign Application Priority Data
Sep. 30, 2013 (CN) 2013104562427

(51) Int. Cl. H01R 13/627

(52) U.S. Cl. CPC H01R 13/6275
USPC 439/577

(57) ABSTRACT

A fixing device for fixing two connectors connected to each other includes two holding members and a connecting member connected between the holding members. Each holding member includes a connecting piece and two arms extending down from opposite ends of the connecting piece to sandwich one of the connectors.

### BACKGROUND

1. Technical Field

The present disclosure relates to a fixing device for fixing two connectors connected to each other.

2. Description of Related Art

Adapting lines are often connected to power lines to lengthen the power lines when the power lines are not long enough. However, connectors of the adapting line and the power line connected to each other are often fixed to each other only with friction. As a result, the connectors are easily disengaged from each other when the connectors are impacted or the lines are pulled by accident.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a fixing device, together with two connectors.

FIG. 2 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

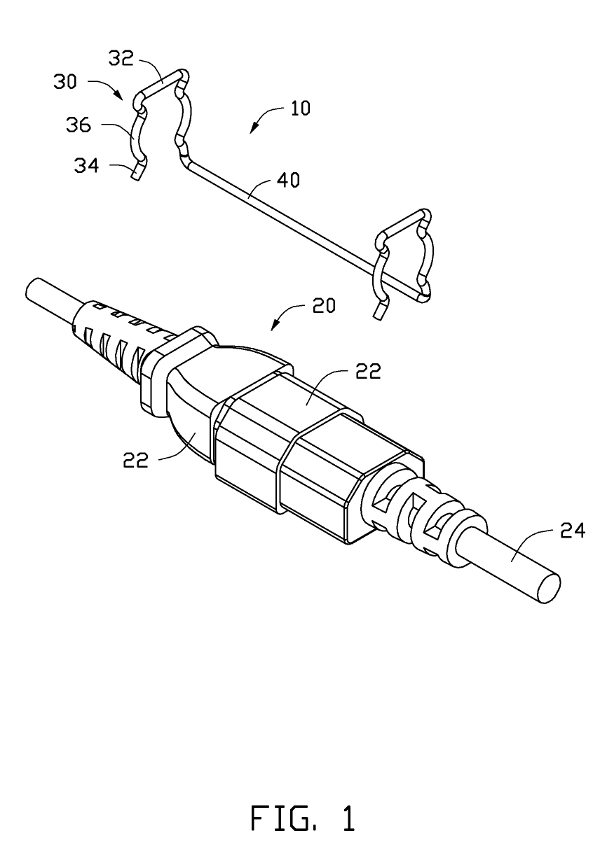

FIG. 1 shows an embodiment of a fixing device 10 for fixing two connectors 20 connected to each other.

The fixing member 10 includes two holding members 30 and a connecting member 40.

Each connector 20 includes a connecting portion 22 and a cable 24 connected to the connecting portion 24.

Each holding member 30 includes a connecting piece 32 and two arms 34 extending down from opposite ends of the connecting piece 32. Middles of the arms 34 are arced away from each other to form two arc-shaped latching portions 36.

A first end of the connecting member 40 is connected to a bottom end of one of the arms 34 of one of the holding portions 30, and a second end of the connecting member 40 is connected to a bottom end of one of the arms 34 of the other holding portions 30. The holding members 30 are located at a same side of the connecting member 40. In the embodiment, the fixing device 10 is made of resilient material, such as metal wire.

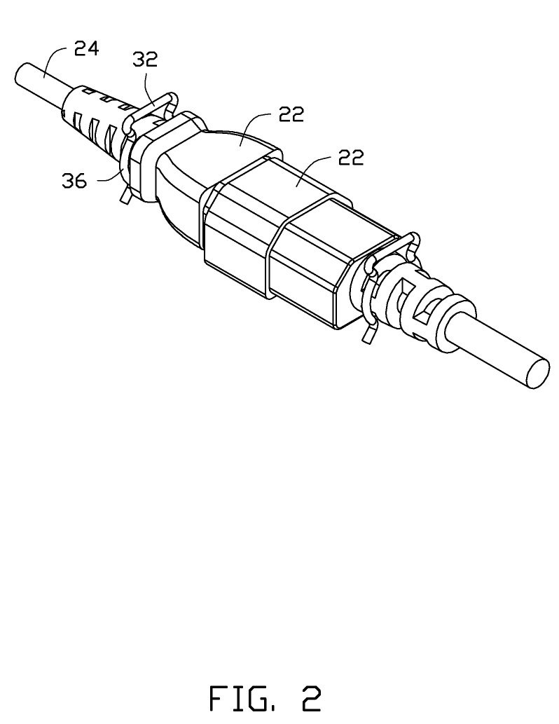

FIG. 2 shows that in assembly, the connecting portions 22 are connected to each other. The arms 34 of each holding member 30 sandwich one of the connectors 20, to allow the latching portions 36 to latch with a portion of the corresponding cable 24 adjacent to the connecting portion 22.

In disengagement of the connectors 20, bottom ends of the arms 34 away from the connecting member 40 are pivoted away from the connecting member 40, to disengage the holding portions 30 from the corresponding connectors 20, therefore, the connectors 20 are ready to be pulled away from each other.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A fixing device for fixing two connectors connected to each other, the fixing device comprising:
two holding members each comprising a connecting piece and two arms extending down from opposite ends of the connecting piece to sandwich one of the connectors; and
a connecting member connected between the two holding members.

2. The fixing device of claim 1, wherein middles of the arms of each holding member are arced away from each other, to form two arc-shaped latching members to latch on the corresponding connector.

3. The fixing device of claim 1, wherein a first end of the connecting member is connected to one of the arms of one of the holding members, and a second end of the connecting member is connected to one of the arms of the other holding member, and the holding members are located at a same side of the connecting member.
